(19) United States
(12) Patent Application Publication
(10) Pub. No.: US 2019/0232464 A1
(43) Pub. Date: Aug. 1, 2019

(54) Lock Rod For Pneumatic Swing Clamp

(71) Applicant: Delaware Capital Formation, Inc., Wilmington, DE (US)

(72) Inventor: Matthew RENTZ, Shelby Township, MI (US)

(21) Appl. No.: 15/882,071

(22) Filed: Jan. 29, 2018

(51) Int. Cl. B25B 5/06; B23Q 1/28

(52) U.S. Cl. CPC B25B 5/062; B23Q 1/28

(57) ABSTRACT

A piston cylinder has a piston housing including a bore. A piston assembly is movable in the piston cylinder bore. The piston assembly includes a piston disk and a piston rod. A lock piston is movable in the piston cylinder. A lock plate is pivotally secured in the piston housing bore. The lock plate is contacted by the lock piston to move the lock plate into an unlocked position when fluid pressure is applied to the lock piston. A biasing mechanism is in contact with the lock plate. The biasing mechanism moves the lock plate into a locked position when fluid pressure is released or reduced on the lock piston.

### FIELD

The present disclosure relates to manual clamps and, more particularly, to pneumatic swing clamps including a piston rod lock.

### BACKGROUND

In various types of pneumatic swing clamps, it is desirable to have a mechanical lock that limits movement of the piston rod. Generally, the lock is activated by an intentional or unintentional loss of fluid pressure in the clamp. Thus, if the fluid pressure is lost in the clamp, the piston rod will be locked in place and movement of the clamp will cease. This enables disconnection from the fluid supply while the swing clamp maintains the clamping force.

The present disclosure provides the art with a mechanical rod lock that is held in an open position by fluid pressure. When the fluid pressure is lost or terminated, the piston rod lock initiates locking by a biasing force applied to a lock plate. The lock plate engages the piston rod, via the biasing force, to halt movement of the piston rod. The rod lock is also activated by a fluid source. Thus, the pressure in the cavity overcomes the biasing force and moves the rod lock into an open unclamped position. The rod lock may include a sensor to enable a pickup to determine if the rod lock is in a clamped (locked) or unclamped (unlocked) position. Also, the clamp may include a device to enable manual override of the rod lock.

### SUMMARY

In accordance with a first aspect of the disclosure, a piston with a locking mechanism comprises a piston housing including a bore with a piston assembly movable in the piston housing bore. The piston assembly includes a piston disk as well as a piston rod. A lock plate is pivotally secured in the piston housing bore. The lock plate is movable into an open, or unlocked position by a lock piston. This occurs when fluid pressure is applied to the lock piston moving the plate lock into an unlocked or open position. A biasing mechanism is in contact with the lock plate to move the lock plate into a locked position when the fluid pressure is released from the lock piston. A sensor may be positioned on the lock plate and in communication with a pickup to indicate a locked or unlocked condition of the lock plate. An opening may be in the housing to enable a tool to pass into the piston housing bore to manually override the lock plate. The biasing member may include a pair of springs. The lock plate further comprises an aperture to enable passage of the piston rod so that a wall defining the aperture contacts the piston rod to lock the piston assembly in position. A pivot is on the piston lock to enable securement of the lock plate inside of the piston housing bore. Also, the pivot provide a pivot point to enable the lock plate to move between its locked and unlocked positions.

According to a second aspect of the disclosure, a swing clamp comprises an outer sleeve having a first and second end. An internal bore extends from the first end to the second end of the outer sleeve. An end cap is positioned adjacent to the first end of the outer sleeve. A rod guide is positioned adjacent the second end of the outer sleeve. A piston assembly is movable in the internal bore. The piston assembly includes a piston and a piston rod with two ends. The piston is movable in the internal bore and the piston rod is coupled at one end with a piston. The other end of the piston rod includes a clamping arm. The piston rod is received and guided in the rod guide. A lock plate is pivotally secured in the piston housing bore. The lock plate is movable to an open or unlock position by a lock piston. This occurs when fluid pressure is applied to the lock piston moving the lock plate into an unlocked or open position. A biasing mechanism is in contact with the lock plate to move the lock plate into a locked position when the fluid pressure is released from the lock piston. A sensor may be positioned on the lock plate and in communication with a pickup to indicate a locked or unlocked condition of the lock plate. An opening may be in the housing to enable a tool to pass into the piston housing bore to manually override the lock plate. The biasing member may include a pair of springs. The lock plate further comprises an aperture to enable passage of the piston rod so that a wall defining the aperture contacts the piston rod to lock the piston assembly in position. A pivot is on the piston lock to enable securement of the lock plate inside of the piston housing bore. The pivot provides a pivot point to enable the lock plate to move between its locked and unlocked positions. The swing clamp also comprises an inner housing assembly to receive the lock plate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the swing clamp in accordance with the present disclosure.

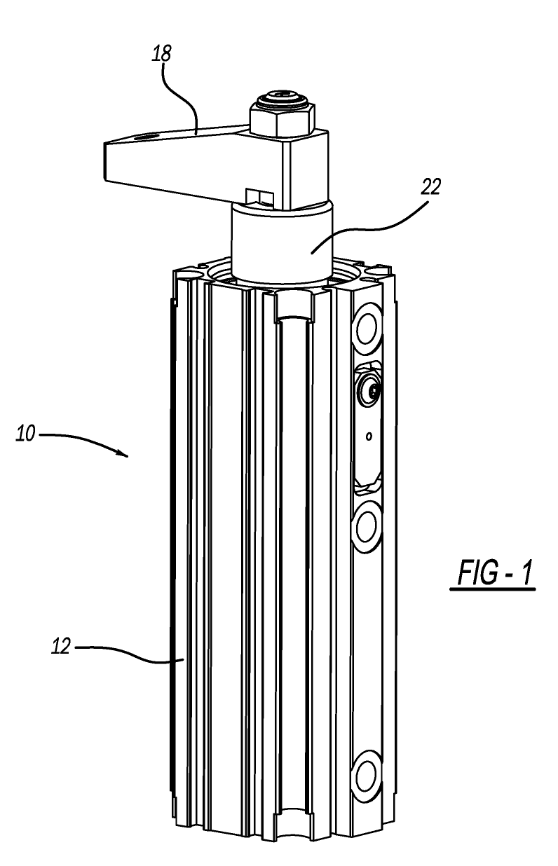

FIG. 2 is a cross-section of FIG. 1 along line 2-2 with the lock plate in a locked position.

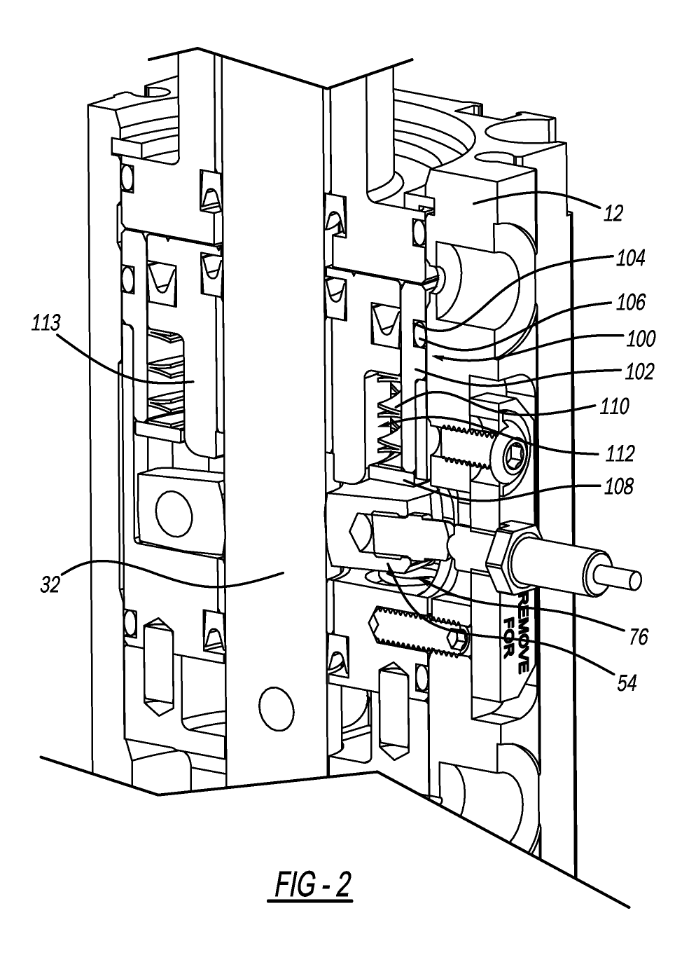

FIG. 3 is a view like FIG. 2 with the locked plate in an unlocked position.

FIG. 4 is a cross-section view like FIG. 2 illustrating a tool moving the lock plate to an unlocked position.

FIG. 5 is an exploded perspective of the swing clamp of FIG. 1

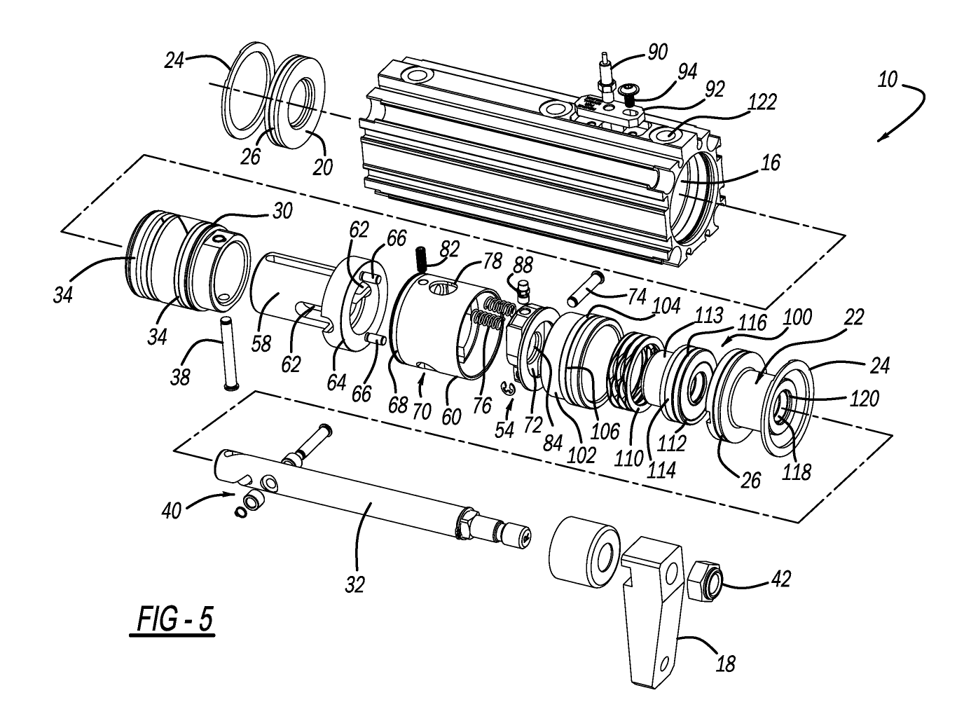

### DETAILED DESCRIPTION

Example embodiments will now be described more fully with reference to the accompanying drawings.

Turning to the figures, a swing clamp is illustrated and designated with the reference numeral 10. The swing clamp includes an outer sleeve 12 with a piston assembly 14 positioned within an internal bore 16 of the sleeve 12. A clamp arm 18 is attached to one end of the piston rod 32. The sleeve 16 includes an end cap 20 sealed at one end of the internal bore 16 and a rod guide 22 sealed at the other end of the internal bore of the sleeve 12.

The end cap 20 is held in the internal bore 16 by a retaining ring 24. Also, an O-ring 26 is positioned about the end cap 20 to seal the end cap in the internal bore 16. The rod guide 22 likewise includes a retaining ring 24 and an O-ring 26 to retain and seal, respectively, the rod guide 32 within the internal bore 16.

The piston assembly 14 includes a piston 30 and piston rod 32. The piston 30 includes various seals 34 to seal the piston within the internal bore 16. A pin 38 passes transversely through the piston 30 to retain the piston rod 32, at its one end, with the piston 30. The piston rod 32 includes a roller bearing assembly 40 that extends through the piston rod transverse to the piston rod's axis. The piston rod 32 has a second end that is threaded or the like to receive a nut 42 that retains the clamping arm 18 on the end of the piston rod 32.

A rod lock assembly 50 is positioned within the internal bore 16. The rod lock assembly includes a housing 52, a lock plate 54 and a lock piston or release piston 56. The housing 52 includes a cylindrical first housing portion 58 and a sleeve 60. The first portion 58 is positioned within the internal bore 16 and includes a pair of slots 62. The slots 62 enable the bearing assembly 40 to roll and move within the first housing portion 58. The sleeve 60 is secured with a flange 64 of the first housing portion 58. Pins 66 retain the sleeve 60 on the first housing portion flange 64. An O-ring 68 is positioned in an annular groove on the sleeve 60 to provide sealing of the housing assembly 52 in the internal bore 16.

The first housing portion 58 and sleeve 60 both include bore to enable passage of the piston rod 32. The sleeve 60 includes a hinge portion 70 that receives a pivot 72 of the lock plate 54. A pin 74 secures the lock plate 54 in the sleeve 60 to provide pivotal movement of the lock plate 54 within the sleeve 60 with respect to the piston rod 32. Also, the sleeve 60 includes bores to receive the springs 76 that bias the lock plate 54. The sleeve 60 includes an aperture 78 that enables a tool 80 to pass into the internal bore to enable a manual override of the lock plate 54.

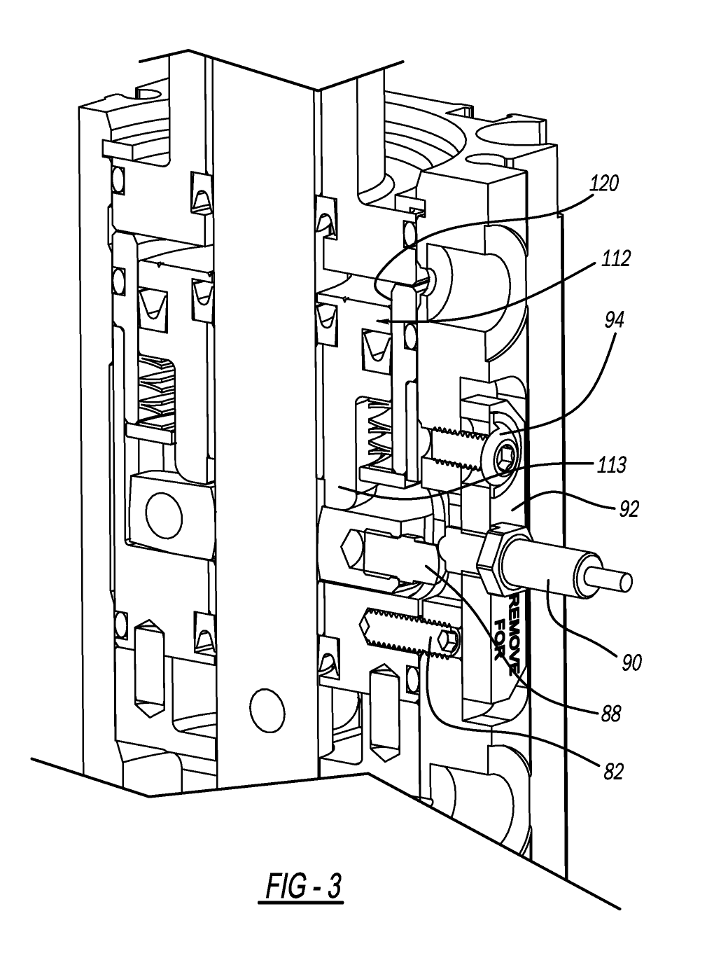

A set screw 82 passes through the outer sleeve 12 to secure the sleeve 60 in position in the internal bore 16. The lock plate also includes an aperture 84 that receives the piston rod 32. The lock plate 54 includes a bore 86 that receives a sensor 88 that can be sensed by a pickup 90 to determine the position of the lock plate 54. Thus, the sensor 88 will indicate whether the lock plate 54 is in a clamped or unclamped position. The sensor pickup 90 is positioned in a cover 92 that is maintained on the outer sleeve 12 by a fastener 94. A locking piston assembly 100 moves the locking plate 54 into its opened or unclamped position as illustrated in FIG. 3.

The locking piston assembly 100 includes a sleeve 102 with an annular recess 104 to receive the O-ring 106 that seals the sleeve 102 within the internal bore 16. The sleeve 102 may include a retaining ring 108 that retains a wave spring 110 and lock piston 112 within the sleeve 102. Also, a seal 114 is positioned around an annular recess 116 in the lock piston 112 to seal the lock piston within the sleeve 102. A bushing 118 with a seal 120 may be positioned inside of the rod guide 20 to provide a sealed cavity 120 within the internal bore 16.

An inlet 124 is bored into the wall of the outer sleeve 12. The inlet 124 receives a pressure source to activate the lock piston assembly 100. As fluid pressure enters the inlet 124, the fluid is passed into the cavity 122. As the pressure builds, the lock piston 112 moves against the force of the wave spring 110 within the sleeve 102. As the pressure continues to build, the lock piston 112, via its nose 113, presses against a surface of the lock plate 54. This continues until the biasing force of the springs 76 is overcome and the lock plate 54 is moved into the unlocked or open position as illustrated in FIG. 3. Thus, the swing clamp 10 can function for its intended purpose.

In the event that the pressure is lost or removed in the cavity 122, the biasing springs 76 act against the opposite surface of the lock plate 54. As this occurs, the lock plate 54 is moved toward the lock piston 112. Accordingly, the wall defining the aperture 84 of the lock plate 54 contacts the piston rod 32. This contact locks the piston rod 32 in position if fluid pressure is lost or reduced in the cavity 122, via intentional or unintentional means. Thus, the piston rod 32 is locked in position when sufficient pressure is not present in the cavity 122.

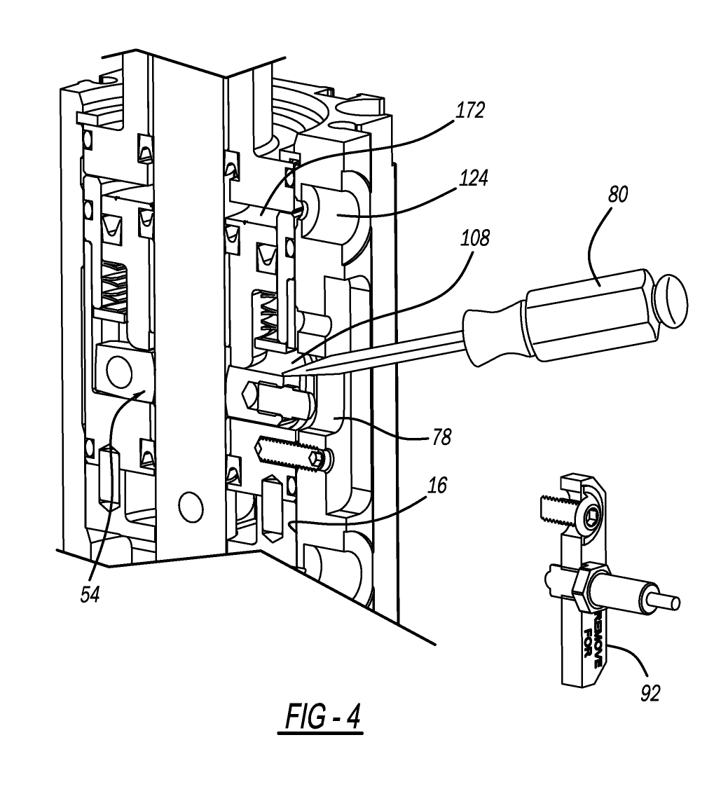

The sensor pickup 90 senses the movement of the sensor 88 to determine whether the lock plate is in an unclamped or clamped position. This information is relayed to a processor and to the user. Also, as illustrated in FIG. 4, a tool can be utilized to manually move the lock plate 54 until the lock piston 112 is initiated to secure the lock plate 54 in an open condition as explained above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A piston cylinder with a locking mechanism comprising:
a piston housing including a bore;
a piston assembly movable in the piston housing bore, the piston assembly including a piston disk and a piston rod;
a lock piston movable on the piston rod;
a lock plate pivotally secured in the piston housing bore, the lock plate contacted by the lock piston to move the lock plate into an unlocked position when fluid pressure is applied to the lock piston; and
a biasing mechanism in contact with the lock plate, the biasing mechanism moving the lock plate into a locked position when fluid pressure is released or reduced on the lock piston.

2. The piston of claim 1, further comprising a sensor on the lock plate for communicating with a pickup to indicate the locked or unlocked position of the lock plate.

3. The piston of claim 1, further comprising an opening in the housing enabling a tool to pass into the piston housing bore to manually override the lock plate.

4. The piston of claim 1, wherein the biasing mechanism includes a pair of springs.

5. The piston of claim 1, the lock plate further comprising an aperture enabling passage of the piston rod so that a wall defining the aperture contacts the piston rod to lock the piston assembly in position, and a pivot securing the lock plate inside the piston housing bore and the pivot providing a pivot point to enable the lock plate to move between its locked and unlocked positions.

6. A swing clamp comprising:
an outer sleeve having a first and second end, an internal bore extending from the first end to the second end of the outer sleeve;
an end cap adjacent the first end of the outer sleeve;
a rod guide adjacent the second end of the outer sleeve;
a piston assembly movable in the internal bore, the piston assembly including a piston and a piston rod with two ends, the piston movable in the internal bore and the piston rod coupled with the piston at one end, the other end of the piston rod including a clamping arm, the piston rod received in the rod guide;
a lock piston movable in the internal bore;
a lock plate pivotally secured in the outer sleeve internal bore, the lock plate contacted by the lock piston to move the lock plate into an unlocked position when fluid pressure is applied to the lock piston; and
a biasing mechanism in contact with the lock plate, the biasing mechanism moving the lock plate into a locked position when fluid pressure is released or reduced on the lock piston.

7. The swing clamp of claim 6, further comprising an inner housing assembly for receiving the lock plate.

8. The swing clamp of claim 6, further comprising a sensor on the lock plate for communicating with a pickup to indicate the locked or unlocked position of the lock plate.

9. The swing clamp of claim 6, further comprising an opening in the housing enabling a tool to pass into the piston housing bore to manually override the lock plate.

10. The swing clamp of claim 6, wherein the biasing mechanism includes a pair of springs.

11. The swing clamp of claim 6, the lock plate further comprising an aperture enabling passage of the piston rod so that a wall defining the aperture contacts the piston rod locking the piston assembly, and a pivot securing the lock plate inside the internal bore and providing a pivot point to enable the lock plate to move between its locked and unlocked positions.
